(19) United States
(12) Patent Application Publication
(10) Pub. No.: US 2020/0320856 A1
(43) Pub. Date: Oct. 8, 2020

(54) Distributed Home Security System And Method Of Responding To An Alert Condition Therefrom

(71) Applicant: HUB6 Inc., Scarborough (CA)

(72) Inventors: Biyun ZHANG, Toronto (CA); Wei Jie CHEN, Toronto (CA)

(73) Assignee: HUB6 Inc., Scarborough (CA)

(21) Appl. No.: 16/566,012

(22) Filed: Sep. 10, 2019

(30) Foreign Application Priority Data
Apr. 4, 2019 (CA) 3039210

(51) Int. Cl. G08B 29/12; G06F 9/455; H04W 4/029; G08B 21/18

(52) U.S. Cl. CPC G08B 29/12; G06F 9/455; G06Q 30/0226; G08B 21/18; H04W 4/029

(57) ABSTRACT

A distributed home security system and a method of responding to alert notifications from that system are provided. They system includes a virtual monitoring module that intercepts alert conditions and sends them to a security server. The security server delivers notifications to main mobile alert devices associated with the virtual monitoring modules. If the main alert mobile devices are unable to respond to the alert conditions the server sends the alert condition to auxiliary mobile alert devices that had accepted to receive such alert notifications. The auxiliary mobile alert devices can report status of the alert condition to the main mobile alert devices via the security server. The auxiliary mobile alert devices may receive reward points for responding to the alert condition.

### FIELD OF THE INVENTION

The present invention relates generally to home security systems, and more specifically to a distributed home security system, and a method of responding to an alert condition therefrom.

### BACKGROUND OF THE INVENTION

Many homeowners and business owners have concerns for their safety and security, and for the contents of their premises to be stolen. Their homes and/or businesses may be at risk of burglaries or other hazards such as fire or floods. As a result, security systems, also known as alarm systems or security alarm systems have become commonplace. Those systems typically include a plurality of sensors used to detect unauthorized entry into the premises, and/or other hazards such as fire or flooding. For example, motion sensors, window sensors, and door sensors all indicate whether an intruder is inside the home, or if a window or a door was opened unexpectedly. Similarly, hazard sensors may include smoke detectors, hazardous gas detectors, and flood monitoring sensors that detect respective hazard conditions. When any of the sensors detects a condition, it provides a signal to a master control panel of the security system. The control panel may in turn produce an alarm sound to alert the occupants of the premises to the alert condition. Additionally, or alternatively, security system may be remotely monitored. In a monitored system, the control panel is in communication with a security monitoring system located remotely from the premises. The control panel may accordingly send the alert condition to that security monitoring system so that the alert condition is handled.

A monitored security system requires its user (such as a homeowner) to pay a monthly subscription fee, which may be a significant cost over the life of the system. Additionally, the user has little flexibility or control over the handling of the alert conditions triggered by the system. The security monitoring service may, for example, have a policy of sending a dispatcher before calling emergency services such as the police. Traffic may hinder the early arrival of the dispatcher, which may have grave consequences. Furthermore, homeowners may not be notified of the condition if they are away from the premises.

There is a need for an enhanced security system that attempts to address the deficiency of the existing systems.

### SUMMARY OF THE INVENTION

In one aspect of the present invention, there is provided a method of notification of an alert condition by a security server in a distributed security system. The method comprises receiving an alert notification from a virtual monitoring module of a security alarm system and checking the status of at least one main alert device. If the status of the at least one main mobile alert device indicates an inability to respond to the alert condition, then: sending the alert condition to at least one auxiliary mobile alert device, tracking a status of the at least one auxiliary mobile alert device, and sending an update of the status of the at least one auxiliary mobile alert device, to the at least one main mobile alert device.

In one embodiment, checking the status of the at least one main mobile alert device comprises computing a distance between a location of the security system and a location of the at least one main mobile alert device.

In another embodiment, checking the status of the at least one main mobile alert device comprises checking an availability indicator of the at least one main mobile alert device.

In one embodiment, checking the status of the at least one main mobile alert device comprises sending the alert condition to the at least one main mobile alert device and not receiving a response therefrom within a predetermined period of time.

In one embodiment, tracking the status of the at least one auxiliary mobile alert device comprises tracking an action status of the at least one auxiliary mobile alert device.

In another embodiment, tracking the status of the at least one auxiliary mobile alert device comprises tracking a location of the at least one auxiliary mobile alert device.

In another aspect of the present invention, there is provided a method for executing on an auxiliary mobile alert device. The method comprises receiving a message indicating an alert condition from a security server, the message including a location of a security system, which generated the alert, sending an indication to accept the alert condition to the security server, and periodically sending an update message containing a location of the auxiliary mobile alert device to the security server. If the location of the auxiliary mobile alert device is the same as the location of the security system, then sending a status update of the alert condition to the security server.

In one embodiment the message further comprises receiving a request message to receive at least one alert condition message from a specific security system and sending a response message indicating an acceptance to receive the at least one alert condition message from the specific security system.

In one embodiment, the method further comprises receiving a message indicating an award of points to the auxiliary mobile alert device.

In yet another aspect of the present invention there is provided a distributed security system. The distributed security system comprises: at least one security system installed at a location, the security system including a plurality of sensors, a master control panel, and a virtual monitoring module; a security server in communication with the virtual monitoring module of the at least one security system; at least one main mobile alert device in communication with the security server; and at least one auxiliary mobile alert device in communication with the security server. The master control panel receives alert conditions from the plurality of sensors. The virtual monitoring module communicates the alert conditions to the security server. The security server checks the status of the at least one main mobile alert device and sends a message containing the alert condition to the at least one auxiliary mobile alert device if the main mobile alert device is not available.

In one embodiment, the virtual monitoring module is connected to the master control panel and configured to intercept alert signals indicating alert conditions.

In one embodiment, the virtual monitoring module receives byte frames from the master control panel, the byte frames including at least one indication of an alert condition.

In one embodiment, the security server comprises a processing module for executing rules to handle alert conditions.

In one embodiment, the security server comprises a networking module for communicating with the virtual monitoring module.

In one embodiment, the security server comprises an alert status table for storing an alert status of the at least one security system.

In one embodiment, the security server comprises an alert registry table for storing the status of the at least one main mobile alert device and the at least one auxiliary mobile alert device.

In one embodiment, the alert condition contains a location of the security system that generated the alert condition.

### BRIEF DESCRIPTION OF THE DRAWINGS

In the attached drawings:

FIG. 1 is a system diagram of a home security alarm showing the main components thereof;

FIG. 2 is system diagram of a security system installed in a home, and remotely connected to a security monitoring service;

FIG. 3 is a block diagram showing the internal components of a master control panel of a monitored security system;

FIG. 4 is a system diagram featuring a security system that sends alerts and receives commands from a mobile device;

FIG. 5 is a block diagram showing the internal components of a security server, in accordance with an embodiment of the present invention;

FIG. 6 is an exemplary representation of an alert status table showing the table schema and sample data;

FIG. 7 is an exemplary representation of an alert notification status table, showing the table schema and sample data;

FIG. 8 is a system diagram featuring a security system that sends alerts to a number of main and auxiliary devices, in accordance with an embodiment of the present invention;

FIG. 9 is a flow chart showing a method performed by a security server to send alerts to a number of main and auxiliary devices, as depicted in FIG. 8; and

FIG. 10 is a flow chart showing a method performed by an auxiliary mobile alert device for handling alert notifications.

### DETAILED DESCRIPTION OF THE EMBODIMENT

Embodiments of the present invention are presented by way of example only, and not limitation with reference to the attached figures.

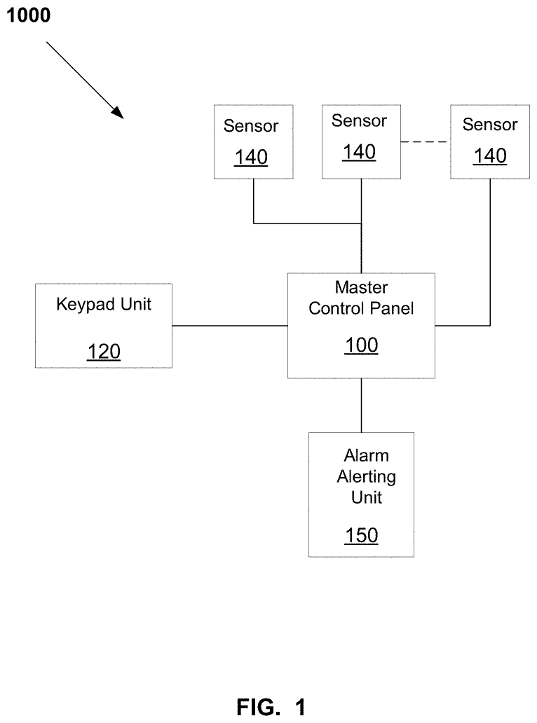

With reference to FIG. 1, a simplified system diagram of a home security alarm system 1000 is shown. The system comprises a master control panel 100, to which a plurality of sensors 140 are connected, in a wired or wireless manner. As discussed in the background section, sensors 140 may be a combination of motions sensors, door sensors, window sensors, smoke detectors, carbon monoxide detectors, and the like. The master control panel 100 is the brains of the security system 1000, and performs various functions such as arming the system, disarming the system, detecting alert conditions reported by the various sensors 140, reporting the status of the various sensors and the system, and configuring alert conditions for various areas of the premises in which the alarm system 1000 is installed. To configure the security system 1000 and to examine the status and configuration thereof a keypad unit 120 is provided. The keypad unit 120 may be a separate physical unit from master control panel 100, or they may be integrated as one unit. The display unit 120 typically has a keypad and a built-in display. The keypad is used to program and configure the security system 1000 by sending configuration commands and parameters to the master control panel 100. In the case where keypad unit 120 is a separate unit from the master control panel 100, they may be connected together in a wired or wireless manner, as known in the art. For example, the two units may be connected using a wired connection such as a serial RS-232 line, an Ethernet connection, a Universal Serial Bus (USB), or the like. Alternatively, or additionally, the keypad unit 120 may be connected to the master control panel 100 by means of a wireless connection such as a Wi-Fi, a Bluetooth connection, or any other suitable wireless link. The keypad unit 120 aids the user in configuring the security system 1000 using its keypad and displays status information about the system on its built-in display. For example, a user may examine the display to determine whether the system is armed, and whether alert conditions have been disabled for certain sensors 140. When an alert condition is triggered, control panel 100 may simply sound an alarm sound using an alarm alerting unit 150. The alarm alerting unit 150 may be a siren or any sound generating device that is used to alert the occupants of the premises in which the security system 1000 is installed.

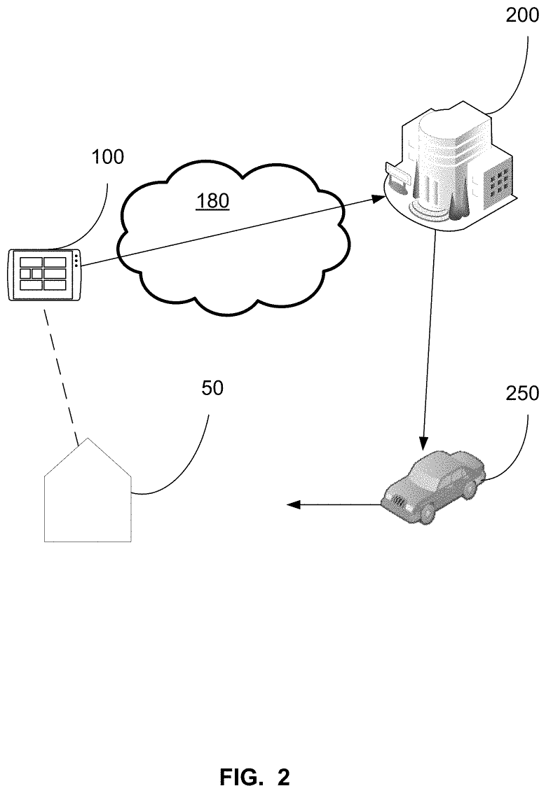

FIG. 2 depicts a security system having a master control panel 100 installed in a home 50, and remotely connected to a security monitoring service 200 over a communication channel, such as the Internet 180. When an alert condition is detected by any of the sensors of the system, an alert message is sent, by master control panel 100, over the communication channel 180 to the security monitoring service 200. In response, the security monitoring service may dispatch a dispatcher 250 to the premises, such as home 50, to investigate the alert condition. The security monitoring service 200 may, alternatively, or additionally call emergency services.

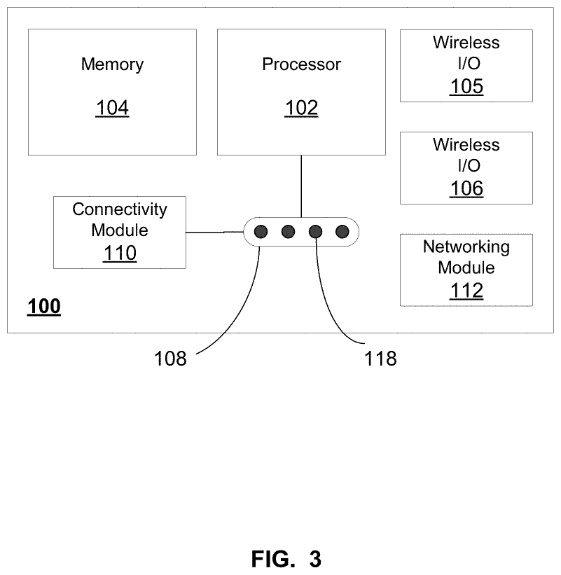

FIG. 3 depicts the internal components of an exemplary master control panel 100 of security system 1000. Master control panel 100 is an embedded system including a processor 102; memory 104; and a group of input/output (I/O), networking, and connectivity modules (105, 106, 110, and 112). Memory 104 stores firmware for execution by processor 102, which is preferably an embedded microcontroller. Connectivity module 110 provides a channel of communication between the master control panel 100 and other components of the system such as keypad unit 120. Processor 102 and connectivity module 110 are connected via a plurality of wires or a bus. The connection between processor 102 and connectivity module 110 is made via a connection header 108. Connection header 108 may comprise a number of connection points 118 connected to a single I/O bus or a number of I/O buses. Each I/O bus may be used to connect to a keypad unit 120 or a third party module. The connection points 118 of connection header 108 may carry signals used to program and configure the control panel 100, and to provide status of the alarm systems. Accordingly, some of the connection points 118 of header 108 are inputs, while some others are outputs. Connection header 108 may also have power and ground connection points 118. The connectivity module 110 provides an interface to the keypad module 120, which allows easy configuration of the control panel 100 and provides for informative status reporting. In one embodiment, the connectivity module monitors the signals on the connection points 118 of header 108 and composes byte frames based on the detected signals. The byte frames report the status of the system 1000 as a whole, including the arming status, as well as the status of the various individual sensors 140, for example. Such byte frames are then sent over a communication channel such as an RS-232 serial connection to the keypad unit 120. Similarly, the connectivity module 110 may receive byte frames comprising configuration commands sent from keypad 120 or from another module also connected to the connectivity module 110 via a serial connection. In the latter case, the connectivity module 110 interprets the commands received in the byte frames, and toggles signals on the connection points 118 of connectivity header 108 based on the received commands. The toggled signals are interpreted by processor 102, which in turn configures the control panel 100 in accordance with the received commands.

Master control panel 100 may also have a wireless I/O module 105 for connection to wireless sensors. The wireless technology used to connect the master control panel 100 and wireless sensors may be Bluetooth, Wi-Fi, or any proprietary RF link. While some sensors may have wireless capability, others may not. Accordingly, wired I/O module 106 may be used to connect wired sensors to master control panel 100, over wired means such as an RS-232 serial connection, an Ethernet connection, a power line connection, or the like.

For a monitored system, control panel 100 needs to report alert conditions to a monitoring service 200, which is typically located remotely from the system 1000. The control panel 100 is provided with a remote networking module 112. The networking module 112 receives alarm status conditions from processor 102, either via header 108 or via connectivity module 110. In the latter case, networking module 112 may have a serial interface, which connects to connectivity module 110, and interprets status information in the byte frames provided by connectivity module 110. Alternatively, remote connectivity module 112 may directly monitor the signals on the connection points 118 of header 108. Remote networking module 112 then communicates with a remote monitoring service 200 to report any alert conditions. Optionally, remote networking module 112 may also receive commands from remote monitoring service 200 to disable the alarm or clear a false alert condition. Remote networking module 112 may have Wi-Fi capability so it can connect to the Wi-Fi network at the premises in which the security alarm system 1000 is installed. Using the Wi-Fi network the control panel 100 utilizes the remote networking module to communicate with the security monitoring service 200 over the Internet. Alternatively, or additionally, the remote networking module may have a cellular modem using a technology such as GPRS, EDGE, or LTE to communicate, over the cellular network and the Internet, with the security monitoring service 200.

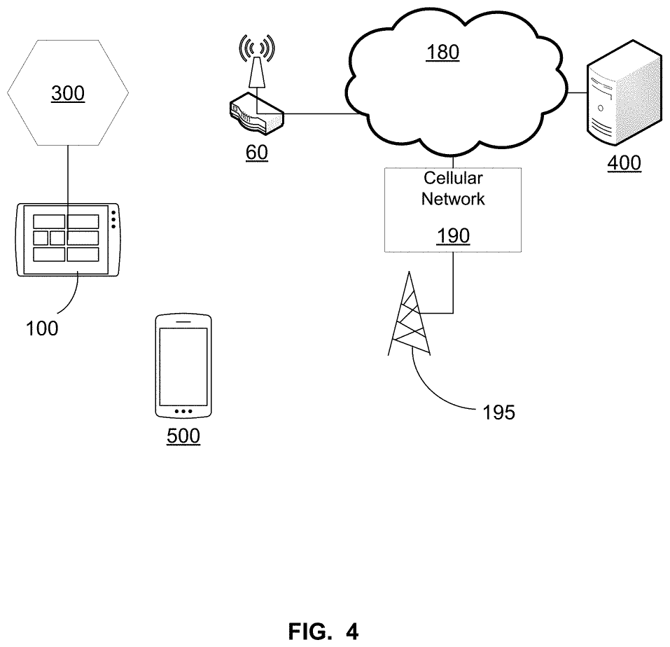

Turning now to FIG. 4, which depicts a security system, which gives direct control thereof to its primary user, such as the homeowner, in accordance with an embodiment of the present invention. The system is comprised of a master control panel 100, an optional keypad unit (not shown), a virtual monitoring module 300, a security server 400, and a mobile application running on a mobile phone 500. The master control panel 100 and keypad unit 120 perform their normal functions as described above. The virtual monitoring module 300 is shown connected to the master control panel 100 via connection 111. In one embodiment, the virtual monitoring module 300 utilizes connectivity module 110, which may be present inside control panel 100 and exchanges status information and commands with control panel 100 in the same manner that the keypad unit 120 does. In another embodiment, the virtual monitoring module 300 taps directly to the wires of header 108, directly interprets the signals on those wires, and toggles those wires to issue commands to the master control panel 100. In one embodiment, the monitoring module 300 may be connected to the keypad unit 120 and may intercept byte frames sent and received by the master control panel 100 to the keypad unit 120. In another embodiment, the keypad unit 120 may be removed entirely and the user can use mobile phone 500 to monitor and control the system 1000.

With reference to FIG. 4, virtual monitoring module 300 is connected to the security server 400 over the Internet 180. The server 400 is in communication with cellular network 190 over the Internet 180 or otherwise. Mobile phone 500 is connected to cellular network 190 via cellular base station 195. Accordingly, a mobile application running on mobile phone 500 can receive notifications sent by the virtual monitoring module 300 over Internet 180 to security server 400, and from there to mobile phone 500 via cellular network 190 and base station 195. Similarly, commands may be entered on a mobile application running on mobile phone 500 and used to configure or control the master control panel 100. The commands are first sent over the cellular network 190, to server 400 which may process the commands, and perform some authentication. If the user is authorized to send commands to the master control panel 100, then the security server 400 sends the command over the Internet 180 to the virtual monitoring module 300 associated with mobile phone 500. The virtual monitoring module 300 may perform additional processing and checks then relay the command to the master control panel 100.

If an alert condition is triggered by control panel 100, and virtual monitoring module 300 intercepts the condition and notifies mobile device 500, the user of mobile device 500 may notify emergency services. However, in some cases it is necessary to verify the alert condition before taking further action. Accordingly, the user of device 500 may wish to travel to the premises to inspect or verify the alert condition. However, there are instances where main device 500 is physically away from the premises. The owner of device 500 may be on vacation or travelling on business. In another case, the device may be offline due to battery outage. In this case, an alert condition may be missed which is highly undesirable. Accordingly, a system is proposed to handle such condition as explained below. The system allows delivery of alert (or alarm) conditions to multiple mobile phones registered with a particular security system.

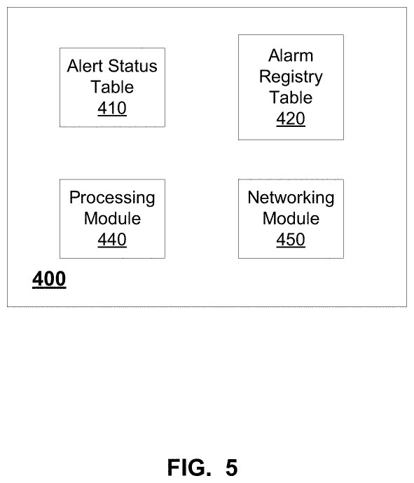

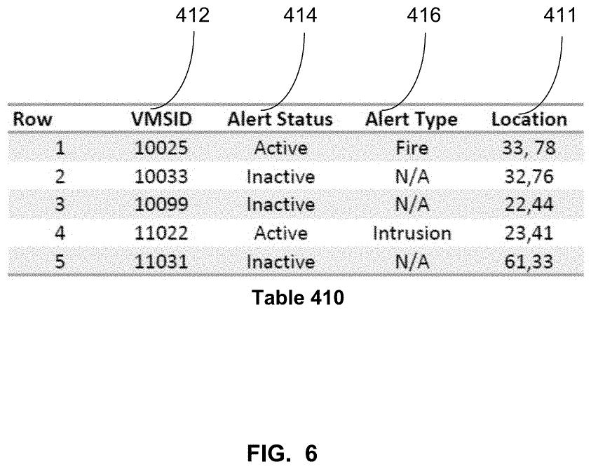

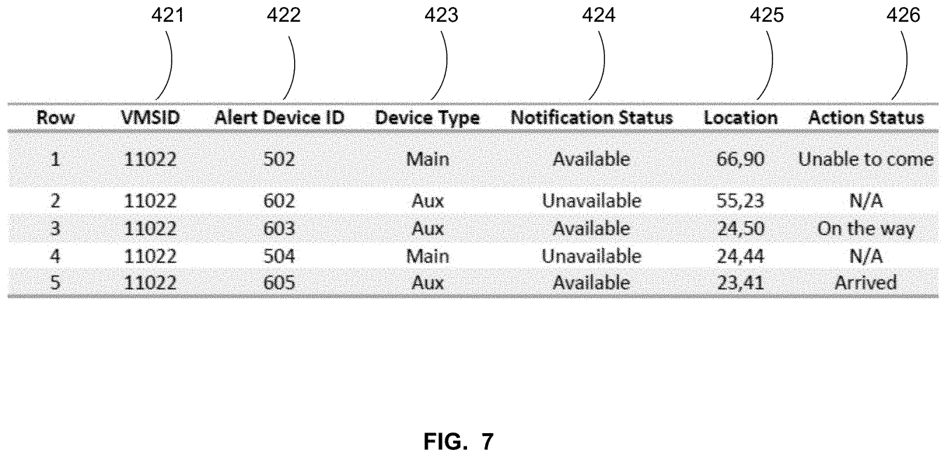

FIG. 5 shows some of the internal components of security server 400, configured to deliver alert conditions to multiple registered mobile phones. The security server 400 includes, among other components: a database system including an alert status table 410 and an alarm registry 420, a processing module 440, and a networking module 450. Networking module 450 communicates with both virtual monitoring modules 300 in various alarm systems and with various mobile phones registered to receive alerts from the monitoring modules. The processing module 440 processes alerts received by the networking module in order to determine the appropriate response or notification to deliver to the mobile phones registered to receive such alerts. The processing module 440 may contain a rules engine (not shown) which is used to determine the appropriate response or notification. The alarm status table 410 stores the alarm status of the various alarm systems registered with server 400. The schema of alert status table 410 is shown in FIG. 6. The alarm registry table 420 stores information about the various mobile phones registered to receive alerts from the various alarm systems having virtual monitoring modules 300 registered with server 400. The schema of alarm registry table 420 is shown in FIG. 7.

FIG. 6 shows the schema of table 410, which is the alert status table of all virtual monitoring modules 300 installed in various premises. Each row in table 410 has a Virtual Monitoring System Identifier (VMSID) 412 identifying the virtual monitoring module 300 installed in particular premises. An alert status field 414 indicates whether an alert has been triggered for the particular module 300 identified by a VMSID 412. In this case, the alert status is “Active”; otherwise, it is “Inactive”. Field 416 identifies the alert type. For example, the alert may be an “Intrusion”, a “Fire”, or a “Medical” emergency. Field 411 stores the location of the alarm system, which is generally determined by the location of module 300. This location may be detected by means of GPS, Wi-Fi, cellular network cell ID, or simply entered into the virtual monitoring module upon installation in the premises.

For example, table 410, shows that there are active alarms in the systems having VMSID of 10025 and 11022. The first alarm has a an alarm type 416 of “Fire”, as shown on row 1, while the second alarm has a type of “Intrusion”, as shown on row 3.

FIG. 7 shows the schema of the alert response table 420. Table 420 has a VMSID 421. Using VMSID from both tables 410 and 420 allows processing module 440 of server 400 to correlate data between the two tables. Table 420 also contains an Alert Device ID field 422. This field contains a device identifier for a mobile device configured to receive alerts from a particular virtual monitoring module 300 identified by a particular VMSID 421. For brevity, only devices registered for receiving alerts from the system identified by a VMSID of 11022 are shown in table 420, but it would be understood by those of skill in the art that table 420 might contain the status of all alert devices registered for all virtual monitoring modules in communication with server 400. The type of the device is stored in field 423. Device types may be “Main” or “Auxiliary”. A main device is one that belongs to one of the owners or occupants of the premises at which the respective alarm system is installed. An auxiliary device is one that does not belong to one of the owners, but one that has been registered as a possible recipient of alerts from that particular system identified by the VMSID. For example, when the virtual monitoring module 300 is installed in a house, the main devices are paired with the virtual monitoring module 300. Then the house owner may invite others, such as neighbors, friends, and relatives to receive alerts from the same system. This may be done via the mobile application installed on the primary alert devices, or otherwise. The method of requesting that auxiliary devices be registered to receive alarms is described below.

Field 424 indicates the notification status of each main or auxiliary device. Even though a device may be registered to receive alerts and/or send commands to particular system identified by a VMSID, the alert device may be unavailable to receive such alerts at a given time. For example, the alert device may be too far from the location of the system that issued the alert, or the alert device may belong to a person who is unable to assist such as a child or an elderly person. Accordingly, the server 400 may receive an indication from each alert device indicating whether the device is currently available to receive alerts from the security alarm system. The server 400 then updates the corresponding field 414 with that information.

Field 425 indicates the location of the alert device. Alert devices may periodically send their location, as detected by GPS or otherwise, to server 400. Accordingly, the server 400 may determine whether the device may be able to respond to a particular alert. As such, the processing module 440 of server 400 may contain a rule that compares the current location 425 of an alert device with the location 411 of the security system and decide whether to notify the alert device of the alert condition from that system. In one embodiment, the main devices are always alerted of the alert conditions even if their location is far from the system. This is because an owner is always interested in alert conditions that are triggered in their system.

Upon receiving an alert condition on a mobile device, whether primary or secondary, the mobile device reports to the server as to whether responding to the alert condition is possible. This is reflected in the action status field 426 of table 420. For example, although a device may be available and does not have a location that is too far from the alarm system that generated the alert condition, the device owner may choose not to respond to the condition if they consider it too hazardous or otherwise. As such, that device may report a condition to that effect shown as the action status.

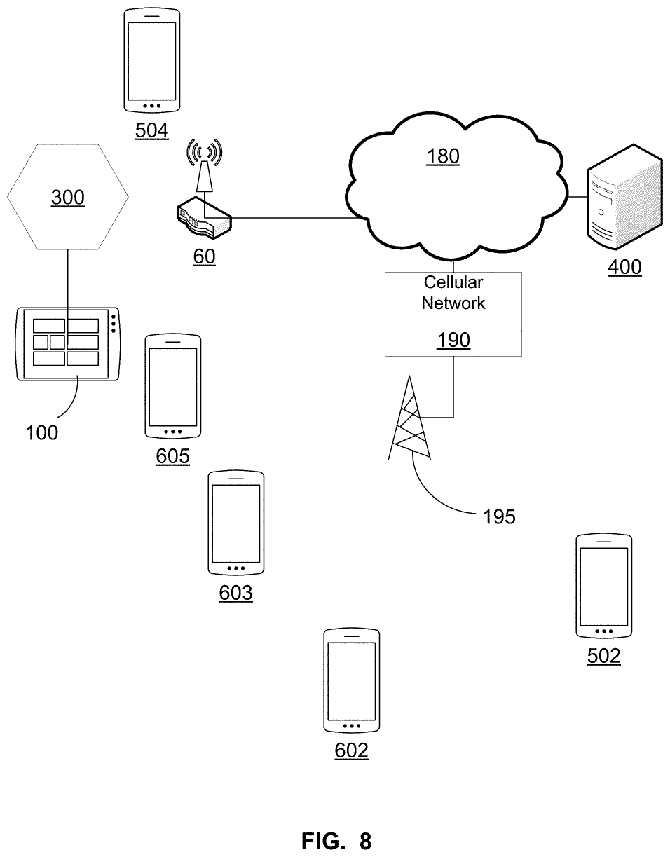

With reference to FIGS. 6, 7, and 8, there is shown an alert condition that triggered for the system having a VMSID of 11022, and how the condition is handled. First with reference to FIG. 8, there are two main devices 502 and 504 associated with the security system having virtual module 300. Device 502 is located far away from the premises in which module 300 is installed, as shown in row 1 of table 420 and comparing the device location 425 with the location 411 of system 11022. It is therefore expected that device 502 will report that it is “unable to come” to respond to the alert condition. Device 504 is used by a child, and is thus marked as unavailable as a child is expected to receive an alert to be warned, but is not expected to respond to an alert by going to the premises. This is despite the fact that device 504 is physically close to the system as indicated by its location reflected in row 4 of table 420 and comparing that with location 411 of row 4 in table 410.

With respect to the auxiliary devices, as shown in FIG. 8, auxiliary device 602 has a location that is too far from the location of system 11022, so it is designated as “unavailable”. Auxiliary alert devices 603 and 605 have both responded positively to the alert condition sent to them by server 400. The action status 426 of device 605, as shown in row 5 of table 420, is that it has arrived at the premises in which system 11022 is installed. Device 603, is shown to be “on the way” to the premises. The status of each alert device may also be sent by server 400 to every other alert device that has responded positively to the alert condition. In one embodiment, only the main device is sent the status update.

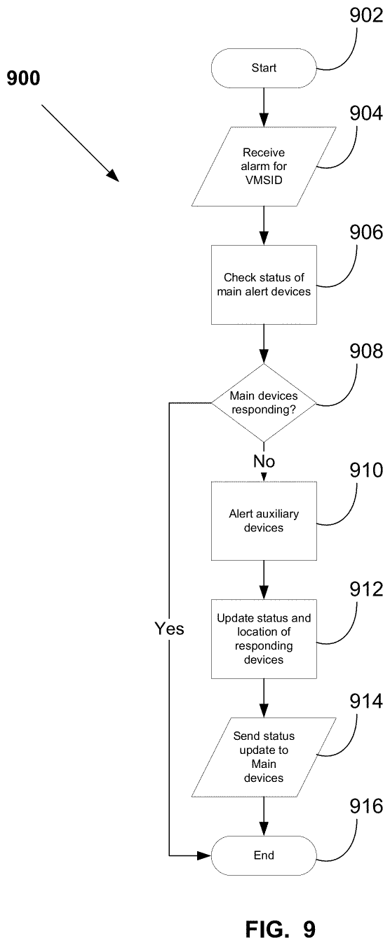

FIG. 9 shows a method 900 executed by server 400 to handle an alert condition triggered by an alarm system having a virtual monitoring module. The method starts at 902. At 904, the server 400 receives an alarm form a virtual monitoring module designated by a particular VMSID. At 906, the server 400 first checks the status of the main alert devices. For example, the server may first send the alert conditions to the main alert devices only and wait for a response within a predetermined period. At 908, the main devices are unavailable, are unable to respond, or simply do not provide any response within the predetermined period, then the server determines that auxiliary devices need to be alerted. As such, auxiliary devices are notified at 910. At 912, the status of auxiliary devices are tracked and updated at the server 400, as explained above. This is done by updating the alert device status table 420. Additionally, at 914, the server 400 may send updates to the main devices for the status of the various alert devices with respect to their response to the alert condition.

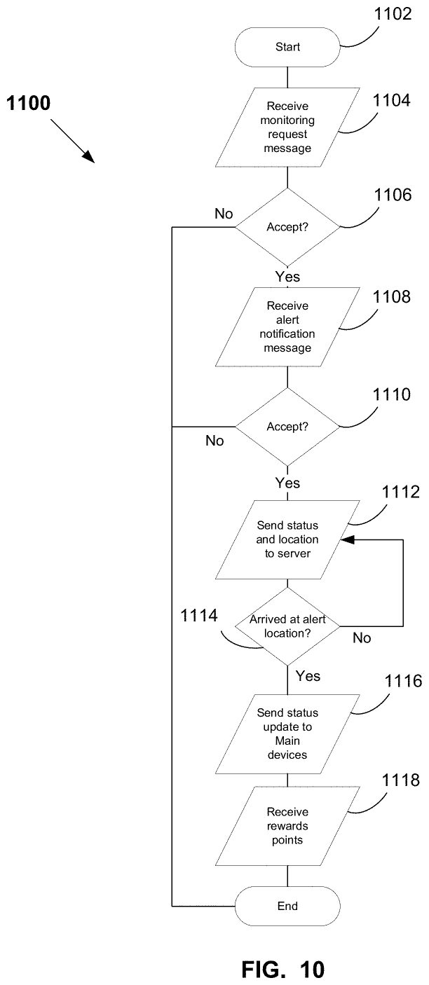

FIG. 10 shows a method 1100 for execution by an auxiliary device. The method starts at 1102. At 1104, the device receives a monitoring request message inviting it to be a designated auxiliary mobile alert device for a particular security system. The provisioning message may be an email explaining the implications of being an auxiliary alert device and a link to install a security alert mobile application. Alternatively, if the alert mobile application is already installed on the auxiliary mobile alert device, then the provisioning message is sent directly to the alert mobile application. At 1106, if the auxiliary mobile alert device refuses to be designated as an auxiliary mobile alert device for the particular security system, then control transfers to the end of the method. If the mobile alert device accepts to receive alerts for the particular security system, then the device waits for an alert. This may be a pre-configured option, or a user interface prompt may appear on a display of the device that requires the device's owner to respond to. At 1108, the auxiliary mobile alert device receives an alert notification message. The alert notification message may contain information about the security system that generated the alert. Such information may include the street address and GPS location of the premises in which the security system is installed. At 1110, if the device determines that it cannot respond to the alert, then control is transferred to the end of the method. The device may determine that it cannot respond to the alert based on the location of the security system and the device's own location. The device may also refuse to respond to the alert condition based on the alert type. For example, the device's owner may configure the alert application to automatically reject responding to fire alarms. If the device determines that it may respond to the alert condition, then at 1112, the device sends its GPS location to the security server. The device may then start a GPS navigation application or the device's owner may travel to the premises that contain the security system, which generated the alert condition. Upon arrival at the premises, at step 1116, the device sends a status update to the main device or devices via the security server. The status update may be a text message, a photograph, a video or a combination thereof. The main device owner then may determine a course of action to handle the alert condition. Advantageously, the system allows a homeowner, for example, to get the status of an alert condition at their home without being there. At 1118, the auxiliary device receives a reward for attending to the alert condition. The reward may be in the form of points, which can be redeemed for goods or services, bitcoins, or any other form of financial incentive.

Although specific embodiments were described, it would be apparent to persons of skill in the art that the described invention may be practiced without being limited to such embodiments. The scope of the invention is determined by the attached claims.

1. A method of notification of an alert condition by a security server in a distributed security system, the method comprising:
receiving an alert notification from a virtual monitoring module of a security alarm system;
checking the status of at least one main alert device;
if the status of the at least one main mobile alert device indicates an inability to respond to the alert condition, then:
sending the alert condition to at least one auxiliary mobile alert device;
tracking a status of the at least one auxiliary mobile alert device; and
sending an update of the status of the at least one auxiliary mobile alert device, to the at least one main mobile alert device.

2. The method according to claim 1, wherein checking the status of the at least one main mobile alert device comprises computing a distance between a location of the security system and a location of the at least one main mobile alert device.

3. The method according to claim 1, wherein checking the status of the at least one main mobile alert device comprises checking an availability indicator of the at least one main mobile alert device.

4. The method according to claim 1, wherein checking the status of the at least one main mobile alert device comprises sending the alert condition to the at least one main mobile alert device and not receiving a response therefrom within a predetermined period of time.

5. The method according to claim 1, wherein tracking the status of the at least one auxiliary mobile alert device comprises tracking an action status of the at least one auxiliary mobile alert device.

6. The method according to claim 1, wherein tracking the status of the at least one auxiliary mobile alert device comprises tracking a location of the at least one auxiliary mobile alert device.

7. A method for executing on an auxiliary mobile alert device, the method comprising:
receiving a message indicating an alert condition from a security server, the message including a location of a security system, which generated the alert;
sending an indication to accept the alert condition to the security server;
periodically sending an update message containing a location of the auxiliary mobile alert device to the security server;
if the location of the auxiliary mobile alert device is the same as the location of the security system, then sending a status update of the alert condition to the security server.

8. The method according to claim 7, further comprising:
receiving a request message to receive at least one alert condition message from a specific security system; and
sending a response message indicating an acceptance to receive the at least one alert condition message from the specific security system.

9. The method according to claim 7, further comprising:
receiving a message indicating an award of points to the auxiliary mobile alert device.

10. A distributed security system, comprising:
at least one security system installed at a location, the security system including a plurality of sensors, a master control panel, and a virtual monitoring module;
a security server in communication with the virtual monitoring module of the at least one security system;
at least one main mobile alert device in communication with the security server; and
at least one auxiliary mobile alert device in communication with the security server;
wherein:
the master control panel receives alert conditions from the plurality of sensors;
the virtual monitoring module communicates the alert conditions to the security server;
the security server checks the status of the at least one main mobile alert device and sends a message containing the alert condition to the at least one auxiliary mobile alert device if the main mobile alert device is not available.

11. The system according to claim 10, wherein the virtual monitoring module is connected to the master control panel and configured to intercept alert signals indicating alert conditions.

12. The system according to claim 10, wherein the virtual monitoring module receives byte frames from the master control panel, the byte frames including at least one indication of an alert condition.

13. The system according to claim 10, wherein the security server comprises a processing module for executing rules to handle alert conditions.

14. The system according to claim 10, wherein the security server comprises a networking module for communicating with the virtual monitoring module.

15. The system according to claim 10, wherein the security server comprises an alert status table for storing an alert status of the at least one security system.

16. The system according to claim 10, wherein the security server comprises an alert registry table for storing the status of: the at least one main mobile alert device and the at least one auxiliary mobile alert device.

17. The system according to claim 10, wherein the alert condition contains a location of the security system that generated the alert condition.
